(19) United States
(12) Patent Application Publication
(10) Pub. No.: US 2014/0326091 A1
(43) Pub. Date: Nov. 6, 2014

(54) Miniature Linear Positioning System

(71) Applicant: VELMEX, INC., Bloomfield, NY (US)

(72) Inventor: Mitchel L. Evans, Canandaigua, NY (US)

(73) Assignee: Velmex, Inc., Bloomfield, NY (US)

(21) Appl. No.: 13/887,447

(22) Filed: May 6, 2013

(51) Int. Cl. F16H 25/20

(52) U.S. Cl. CPC F16H 25/20
USPC 74/89.32

(57) ABSTRACT

A linear positioning system is miniaturized by using a low profile guide extrusion supporting a low profile carriage that can be moved along the guide by a drive screw. The guide includes coplanar mounting flanges, C-slots for receiving electric wires, and angled recesses to serve as ways for guiding the carriage. The carriage has an opposed pair of projections fitting the guide ways to allow the carriage to move along the guide, and the drive screw and carriage are arranged closely above the guide profile to contribute to dimensional compactness.

### BACKGROUND

Customers for linear positioning systems have repeatedly asked for more compact systems that take up less of the valuable space in their equipment. The miniaturization to reduce the space occupied by positioning systems is requested to perform at least as accurately as larger predecessor systems. Honoring these requests has taken three years of developmental work changing the configurations of elements involved, working out ways to manufacture the improved systems, and testing components for durability and accuracy. The embodiments and variations described in this application concentrate on the features that have made a miniaturization of linear positioning systems successful.

### SUMMARY

The miniaturizing improvement applies to linear positioning systems having a drive screw moving a carriage along a guide. The guide is preferably formed as an extrusion having a low profile extending uniformly along a linear length of the guide. The guide profile preferably includes: coplanar mounting flanges extending along opposite sides of the guide; an opposed pair of C-slots arranged closely above the flanges to receive electric wires; and an opposed pair of angled recesses arranged closely above the C-slots to serve as ways guiding the carriage. The carriage also preferably has an opposed pair of projections adjustably fitting the guide ways to allow the carriage to move along the guide, and the drive screw and the carriage are arranged closely above the guide profile to contribute to dimensional compactness.

### DRAWINGS

FIG. 1 is an isometric view of a preferred embodiment of a linear positioning system.

FIG. 2 is an exploded view of the system of FIG. 1.

FIG. 3 is an isometric view of a pair of linear positioning devices arranged in an XY configuration.

FIG. 4 is an exploded view of the devices of FIG. 3.

FIG. 5 is an end view of a guide and a carriage

FIG. 6 is an exploded view of the guide and carriage of FIG. 5.

FIG. 7 is an enlarged view of a fragment of FIG. 6.

FIG. 8 is a plan view of a fragment of a guide.

### DETAILED DESCRIPTION

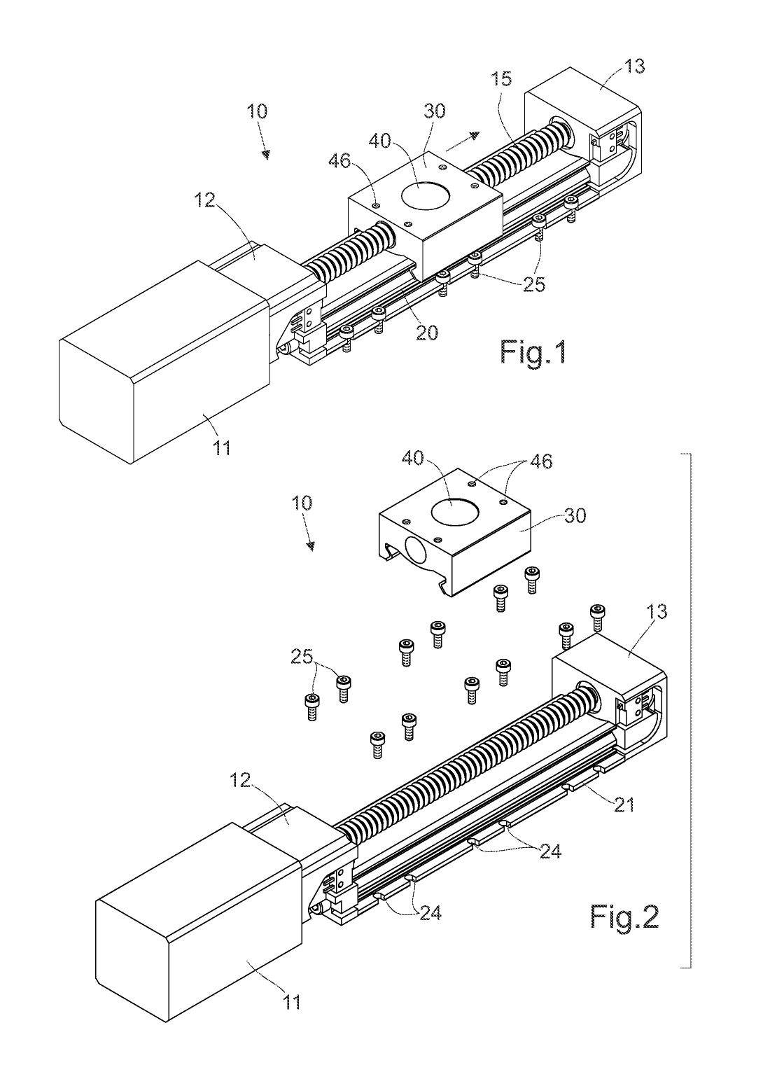

The need for miniaturization applies to linear positioning systems such as system 10 of FIG. 1. Giving system 10 a low profile and compact dimensions requires that special attention be paid to guide 20, carriage 30, and drive screw 15. Components such as motor 11, coupler 12, and end bearing 13 for screw 15 are available in different usable sizes. Screw 15 is preferably not smaller than a 7 mm diameter so that it can extend for a required distance without sagging between its end supports. The guide 20 and the carriage 30 then become the elements needed for a miniaturization to succeed in making positioner 10 compact.

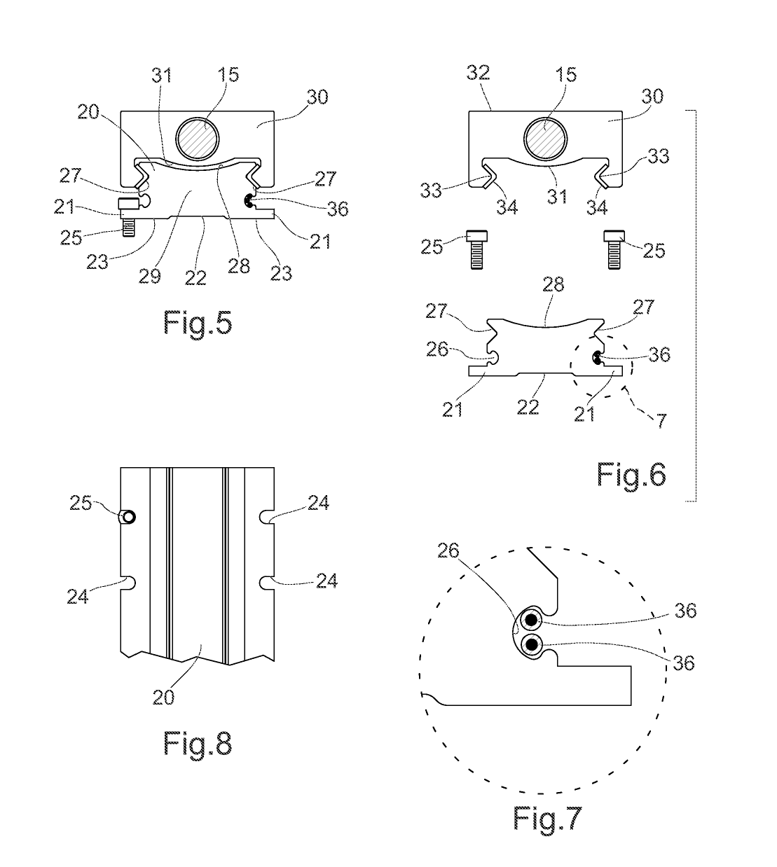

Guide 20 is an extrusion as shown in each of the drawings, and guide 20 is most clearly depicted in FIGS. 5-8. The guide 20 extrusion has a low profile that extends uniformly along a linear length of guide 20. The profile of guide 20 includes: opposed and coplanar flanges 21 extending along opposite sides of guide 20; and a shallow recess 22 preferably extending between flanges 21 on an underside of guide 20. This assures that coplanar bottom surfaces 23 on the underside of flanges 21 can provide a solid support when mounted on a flat surface. Guide 20 also preferably has sufficient material in its central body 29 above flanges 21 so that guide 20 can extend without warping or bending for the length of the desired linear travel of the positioner. Flanges 21 also preferably have periodic notches 24 to receive mounting screws 25 securing guide 20 to a support surface.

Spaced closely above flanges 21 on opposite sides of guide 20 are opposed C-slots 26 disposed to receive and retain electric wires 36 as shown in FIGS. 5, 6, and 7. This eliminates the need for running electric wires below or alongside guide 20 where they might require an increased profile.

Closely above C-slots 26 and below the top surface 28 of guide 20 are an opposed pair of angle slots 27 that form guide ways for carriage 30. Angled carriage projections 33 are preferably adjustable in a generally known way to achieve a sliding fit in guide ways 27.

Carriage 30 is also preferably formed as an extrusion that is cut to relatively short lengths. Its opposed projections 33 have bearing surfaces 34, which are preferably adjustable for a smooth sliding fit in ways 27 of guide 20 as best shown in FIG. 6. A generally known nut 40 (shown in FIGS. 1-4) is arranged inside carriage 30 to have threads meshing with drive screw 15 so that rotation of screw 15 moves carriage 30 along guide 20. The projections 33 of carriage 30 are preferably covered by bearing material 34 to assure a smooth sliding fit as carriage 30 travels along a guide 20.

A top surface 28 of guide 20 is concave, as best shown in FIGS. 5 and 6 to approximately match a lower convex surface 31 of carriage 30. The convex surface 31 makes room for the material of carriage 30 to surround drive screw 15. This ensures that the carriage material has adequate strength to minimize deflections from external forces applied to the carriage. This also ensures that screw 15 is positioned closely above concave surface 28 of guide 20. Surfaces 21 and 28 thus cooperate in reducing the vertical profile from the top 32 of carriage 30 and the underside of guide flanges 21.

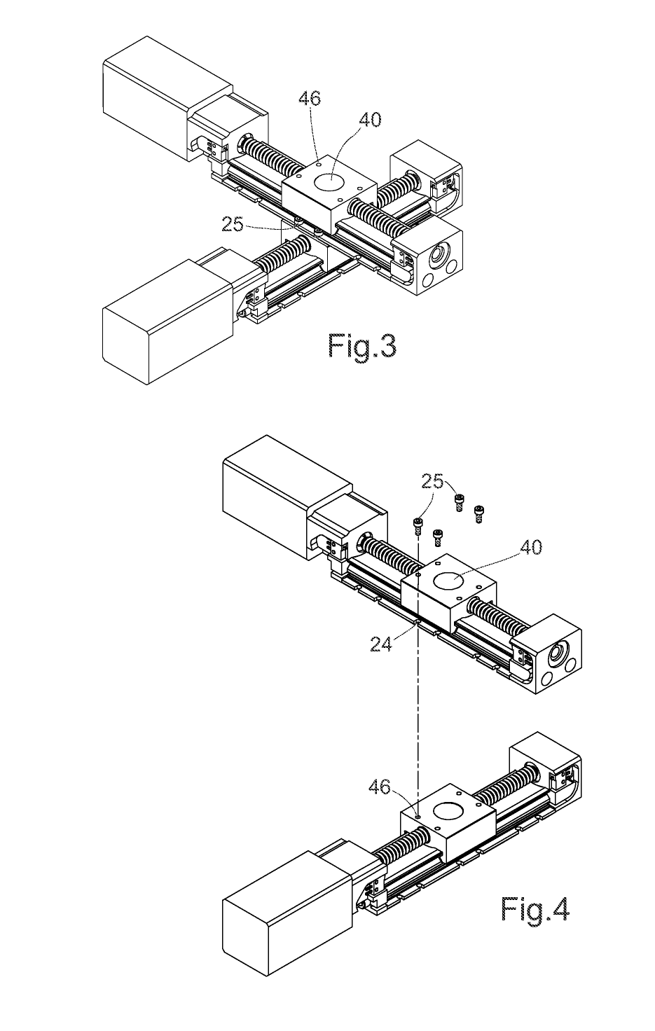

The exploded view of FIG. 2 shows an array of mounting screws 25 arranged in slots 24 of flanges 21 for mounting the positioner on a flat surface. This can help keep positioner 10 rigid throughout its useful length. Also appearing in FIGS. 1-4 are drilled and tapped holes 46 in carriages 30 to receive mounting screws 25 for a superposed positioner such as shown in FIGS. 3 and 4. This allows a pair of positioners 10 to be arranged at right angles to each other to move the top carriage 30 in a field defined by X and Y axes.

The miniaturization achieved as shown in the drawings and described above uses a size 11 electric motor that is 28 mm wide and tall, for driving the 7 mm diameter screw 15. This results in the axis of screw 15 being 14.5 mm above the surface on which the 28 mm wide flanges 21 rest. This makes positioner 10 significantly more compact with a profile that is both lower and narrower. The size reduction also achieves an improvement in accuracy and durability.

What is claimed is:

1. In a linear positioning system having a drive screw moving a carriage along a guide, a miniaturizing improvement comprising:
the guide is an extrusion having a low profile that extends uniformly along a linear length of the guide;
the guide profile includes coplanar mounting flanges extending along opposite sides of the guide;
the guide profile includes an opposed pair of C-slots arranged closely above the flanges to receive electric wires;
the guide profile includes an opposed pair of angled recesses arranged closely above the C-slots to serve as ways for guiding the carriage;
the carriage having an opposed pair of projections fitting the guide ways to allow the carriage to move along the guide; and
the drive screw and the carriage are arranged closely above the guide profile to contribute to dimensional compactness.

2. The system of claim 1 wherein the guide profile includes a concave top surface confronting a convex surface of the carriage.

3. The system of claim 1 wherein the flanges are periodically notched to receive mounting screws.

4. The system of claim 1 wherein the guide profile includes a shallow space between the flanges on an underside of the guide.

5. The system of claim 1 wherein a top surface of the carriage is flat to mount a crosswise guide in an XY configuration.

6. A combination of elements arranged to miniaturize a linear positioning system having a drive screw moving a carriage along a guide, the combination comprising:
the guide is an extrusion having a low profile that extends uniformly along a linear length of the guide;
the guide profile includes an opposed pair of coplanar flanges arranged for mounting the guide on a flat surface;
the guide profile has opposed and angled recesses providing ways for sliding movement of the carriage along the guide;
the carriage has opposed projections shaped to glide along the guide ways;
the flanges of the guide being notched periodically to receive guide mounting screws; and
the drive screw and the carriage are arranged closely above the guide profile to contribute to dimensional compactness.

7. The combination of claim 6 wherein the guide has opposed C-slots to receive electric wires.

8. The combination of claim 7 wherein the C-slots are closely above the flanges and the angled recesses are closely above the C-slots.

9. The combination of claim 6 wherein a top surface of the guide profile is concave to create space for receiving a portion of the carriage and the drive screw.

10. The system of claim 6 wherein the guide profile includes a shallow space between the flanges on an underside of the guide.

11. The system of claim 6 wherein a top surface of the carriage is flat to mount a crosswise guide in an XY configuration.

12. A combination of elements arranged to miniaturize a linear positioning system having a drive screw moving a carriage along a guide, the combination comprising:
the guide is an extrusion having a low profile that extends uniformly along a linear length of the guide;
the guide profile including an opposed pair of C-slots adapted to receive electric wires;
the guide profile including an opposed pair of angled recesses forming ways for the carriage to move along the guide;
the pair of C-slots are closely and respectively below the pair of recesses;
the carriage having angled projections fitting the recessed ways; and
the drive screw and the carriage are arranged closely above the guide profile to contribute to dimensional compactness.

13. The combination of claim 12 wherein the guide profile includes a pair of flanges arranged on opposite sides of the guide and extending along the length of the guide, the flanges being coplanar to be mountable on a flat surface.

14. The combination of claim 13 wherein the C-slots are closely above the flanges.

15. The combination of claim 13 wherein the flanges are periodically notched to receive mounting screws.

16. The combination of claim 12 wherein the profile of the guide includes a concave surface allowing room for a convex surface of the carriage in a region where the carriage surrounds the drive screw.

17. The system of claim 12 wherein the guide profile includes a shallow space between the flanges on an underside of the guide.

18. The system of claim 12 wherein a top surface of the carriage is flat to mount a crosswise guide in an XY configuration.
